(19) United States
(12) Patent Application Publication
(10) Pub. No.: US 2018/0218724 A1
(43) Pub. Date: Aug. 2, 2018

(54) METHOD AND SYSTEM TO MONITOR AND ADJUST PLURALITY OF SOUND WAVES

(71) Applicant: Cheng Wai Man, San Jose, CA (US)

(72) Inventor: Cheng Wai Man, San Jose, CA (US)

(73) Assignee: Cheng Wai Man, San Jose, CA (US)

(21) Appl. No.: 15/420,101

(22) Filed: Jan. 31, 2017

(51) Int. Cl. G10K 11/178

(52) U.S. Cl. CPC G10K 11/1788; G10K 2210/3016; G10K 2210/3051

(57) ABSTRACT

A method and system to monitor and adjust sound waves. The system includes microphone unit, noise-cancellation circuitry, input audio source, processing unit, and microcontroller unit. The microphone unit detects ambient sound waves after turning on microphone unit. The noise-cancellation circuitry creates sound waves that are 180 degrees out of phase with the detected ambient sound waves to cancel ambient sound waves. The processing unit processes sound waves received from noise-cancellation circuitry and audio signals received from input audio source into output sound waves, and further measures quantified level of loudness of output sound waves. The microcontroller unit aggregates, and compares received quantified level of loudness of output sound waves with a pre-stored quantified value of sound waves. The processing unit adjusts output sound waves to pre-defined value of sound waves in case compared quantified level of loudness of output sound waves exceeds from the pre-stored quantified value of sound waves.

### TECHNICAL FIELD

The present invention is generally related to an audio device, particularly to the system and method for monitoring plurality of sound waves, and further adjusting the sound waves based on the monitored sound waves.

### BACKGROUND

Noise-induced hearing loss (NIHL) is a hearing impairment that results from prolonged exposure to high levels of noise or sound. NIHL is a global health issue and is the third most common health problem in the United States. People may have a loss of perception of a narrow range of frequencies, impaired cognitive perception of sound, or sensitivity to sound or ringing in the ears. Teenagers and young adults are at risk of hearing loss due to unsafe listening practices. Also, in noisy environments, it is common for users to drown out the external noise by increasing the volume levels of their music to unsafe levels, which puts their hearing at risk.

Traditionally, there are 2 key factors that cause NIHL. First is intensity (or loudness) of noise, measured in decibels (dB), and second is duration of exposure to the noise. The existing solutions and mechanisms use strict volume limitations, and light indication of unsafe volume levels. However these solutions have various adverse effects and user can not increase the volume level to enjoy the audio and further fails to provide external noise cancellation, Therefore, there is a need of methods and systems to optimize the user's enjoyment and increase the safety. Further there is also a need of methods and systems to monitor the sound waves and automatically adjust the sound waves when the time duration of maximum exposure is reached.

Further limitations and disadvantages of conventional and traditional approaches will become apparent to one of skill in the art through comparison of described systems with some aspects of the present disclosure, as set forth in the remainder of the present application and with reference to the drawings.

### DISCUSSION OF RELATED ART

U.S. Pat. No. 7,817,803 B2 of Steven W. Goldstein is related to monitoring the ambient noise level and the audio level produced by an ear canal receiver (ECR) and incorporating both into a total sound pressure level (SPL) dosage value. However, U.S. Pat. No. 7,817,803 B2 fails to reduce or eliminate the ambient noise. The U.S. Pat. No. 7,817,803 B2 is also not talking about measuring speaker volume and adjusting speaker volume.

US 20130202121 A1 of Archiveades Georgiou et al. talks about warning and/or reduction of risk of ear damage. However, US 20130202121 A1 does not talk about actively tracking the unsafe volume levels that user listens at, as well as duration of exposure to each level.

U.S. Pat. No. 6,456,199 B1 of Kevin Michael talks about a noise monitoring system. However, US 20130202121 A1 does not talk about the cancellation of external noise, monitoring of volume levels that user listens at, automatic alerts and volume adjustments.

Various embodiments of the present invention target the requirements mentioned above and others related thereto.

### SUMMARY OF THE INVENTION

According to the embodiments illustrated herein, a system to monitor plurality of sound waves, and further adjust the sound waves based on the monitored sound waves is provided. The system includes a microphone unit, a noise-cancellation circuitry, a processing unit, and a microcontroller unit. The microphone unit detects plurality of ambient sound waves after turning on the microphone unit. The noise-cancellation circuitry creates sound waves that are 180 degrees out of phase with the detected ambient sound waves in order to cancel plurality of ambient sound waves. The processing unit processes the sound waves received from the noise cancellation circuitry and audio signals received from an input audio source into plurality of output sound waves. In an embodiment, the processing unit measures a quantified level of loudness of the output sound waves. The microcontroller unit aggregates and compares the received quantified level of loudness of output sound waves with a pre-stored quantified value of sound waves. In an embodiment, the processing unit adjusts the output sound waves to a pre-defined value of sound waves in case the compared quantified level of loudness of the output sound waves exceeds from the pre-stored quantified value of the sound waves.

According to the embodiments illustrated herein, a method for monitoring plurality of sound waves, and further adjusting the sound waves based on the monitored sound waves is provided. The method includes the step of detecting plurality of ambient sound waves through a microphone unit. Then the method includes the step of creating sound waves that are 180 degrees out of phase with the detected ambient sound waves in order to cancel plurality of ambient sound waves through a noise-cancellation circuitry. Further the method includes the step of processing the sound waves received from the noise cancellation circuitry and audio signals received from an input audio source into plurality of output sound waves through a processing unit. In an embodiment, the processing unit further measures a quantified level of loudness of the output sound waves.

Furthermore, the method includes the step of aggregating and comparing the received quantified level of loudness of output sound waves with a pre-stored quantified value of sound waves through a microcontroller unit. In an embodiment, the processing unit adjusts the output sound waves to a pre-defined value of sound waves in case the compared quantified level of loudness of the output sound waves exceeds from the pre-stored quantified value of the sound waves.

These features and advantages of the present disclosure may be appreciated by reviewing the following description of the present disclosure, along with the accompanying figures wherein like reference numerals refer to like parts.

### BRIEF DESCRIPTION OF DRAWINGS

The accompanying drawings illustrate the embodiments of systems, methods, and other aspects of the disclosure. Any person with ordinary skills in the art will appreciate that the illustrated element boundaries (e.g., boxes, groups of boxes, or other shapes) in the figures represent an example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate, not limit, the scope, wherein similar designations denote similar elements, and in which:

FIG. 1 is a block diagram that illustrates a system to monitor plurality of sound waves, and further adjust the sound waves based on the monitored sound waves, in accordance with at least one embodiment; and

FIG. 2 is a flowchart that illustrates a method for monitoring plurality of sound waves, and further adjusting the sound waves based on the monitored sound waves, in accordance with at least one embodiment.

### DETAILED DESCRIPTION

The present disclosure is best understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

References to “one embodiment”, “at least one embodiment”, “an embodiment”, “one example”, “an example”, “for example”, and so on indicate that the embodiment(s) or example(s) may include a particular feature, structure, characteristic, property, element, or limitation, but not every embodiment or example necessarily includes that particular feature, structure, characteristic, property, element, or limitation. Furthermore, repeated use of the phrase “in an embodiment” does not necessarily refer to the same embodiment.

Unless defined otherwise, all technical and scientific terms used herein have the same meaning as commonly understood by one of the ordinary skills in the art to which this invention belongs. Although any method and material similar or equivalent to those described herein can also be used in the practice or testing of the present invention, the preferred methods and materials have been described. All publications, patents, and patent applications mentioned herein are incorporated in their entirety.

It is noted that as used herein and in the appended claims, the singular forms “a”, “and”, and “the” include plural referents, unless the context clearly dictates otherwise. In the claims, the terms “first”, “second”, and so forth are to be interpreted merely as ordinal designations; they shall not be limited in themselves. Furthermore, the use of exclusive terminology such as “solely”, “only”, and the like in connection with the recitation of any claim element is contemplated. It is also contemplated that any element indicated to be optional herein may be specifically excluded from a given claim by way of a “negative” limitation. Finally, it is contemplated that any optional feature of the inventive variation(s) described herein may be set forth and claimed independently or in combination with any one or more of the features described herein.

All references cited herein, including publications, patent applications, and patents, are hereby incorporated by reference to the same extent as if each reference were individually and specifically indicated to be incorporated by reference, and were set forth in its entirety herein.

The recitation of ranges of values herein is merely intended to serve as a shorthand method of referring individually to each separate value falling within the range, unless otherwise indicated herein, and each separate value is incorporated into the specification as if it were individually recited herein.

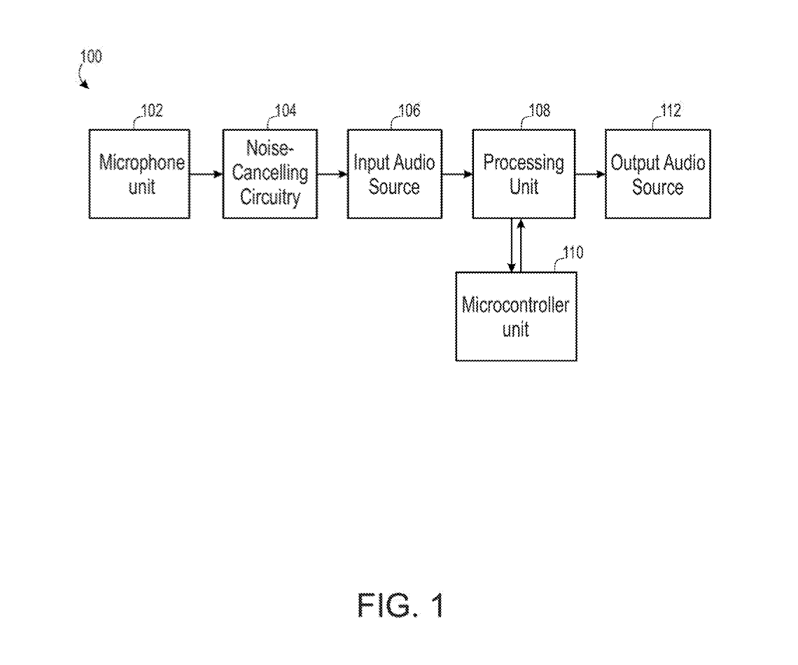

FIG. 1 is a block diagram that illustrates a system 100 to monitor plurality of sound waves, and further adjust the sound waves based on the monitored sound waves, in accordance with at least one embodiment. The system includes a microphone unit 102, a noise-cancellation circuitry 104, an input audio source 106, a processing unit 108, a microcontroller unit 110, and an output audio source 112.

The microphone unit 102 detects plurality of ambient sound waves after turning on the microphone unit 102. The noise-cancellation circuitry 104 creates sound waves that are 180 degrees out of phase with the detected ambient sound waves in order to cancel plurality of ambient sound waves.

The processing unit 108 processes the sound waves received from the noise cancellation circuitry 104 and audio signals received from an input audio source into plurality of output sound waves. In an embodiment, the processing unit 108 measures a quantified level of loudness of the output sound waves. In an embodiment, the processing unit is a digital signal processor (DSP).

The microcontroller unit 110 aggregates and compares the received quantified level of loudness of output sound waves with a pre-stored quantified value of sound waves. The pre-stored quantified value of sound waves is about 85 decibels (dB) because listening to sound waves or audio above 85 dB for extensive periods is at risk.

The microcontroller unit 110 stores the measured quantified level of loudness of the output sound waves with respect to a total time duration for further comparison. The world health organization (WHO) specifies that any sound waves (noise) more than 85 dB is considered unsafe, and has made the recommendations mentioned in the Table 1 on permissible daily noise exposures.

TABLE 1

| Loudness (decibels) | Maximum exposure (minutes) |
|---|---|
| 85 dB | 480 minutes |
| 90 dB | 150 minutes |
| 95 dB | 47 minutes |
| 100 dB | 15 minutes |
| 105 dB | 4 minutes |

Further, the microcontroller unit 110 calculates and compares the total time duration with a pre-defined time duration, thereafter plurality of instructions are transmitted to the processing unit 108. Table 2 shows the calculation of the total time duration. The “Time Count” is calculated for each range of output loudness, based on the recommended daily maximum exposure according to the World Health Organization (WHO) and the way the system measures output volume level every 5 seconds.

TABLE 2

| | Time Count | Recommended | | No. of times | |
|---|---|---|---|---|---|
| | (Subtracted from | max exposure | | system measures | |
| | 8121600 every 5 | (according to | | loudness (every 5 | How time count |
| Loudness Levels | seconds | WHO) | | seconds | is calculated |
| L >103 dB | 169200 | 4 | minutes | 240/5 = | 8121600/48 = |
| | | (240 | seconds) | 48 times | 169200 |
| 103 db > L > 98 dB | 45120 | 15 | minutes | 900/5 = | 8121600/180 = |
| | | (900 | seconds) | 180 times | 45120 |
| 98 dB > L > 93 dB | 14400 | 47 | minutes | 2820/5 = | 8121600/564 = |
| | | (2820 | seconds) | 564 times | 14400 |
| 93 dB > L > 88 dB | 4512 | 150 | minutes | 9000/5 = | 8121600/1800 = |
| | | (9000 | seconds) | 1800 times | 4512 |
| 88 dB > L > 83 dB | 1410 | 480 | minutes | 28800/5 = | 8121600/5760 = |
| | | (28800 | seconds) | 5760 times | 1410 |

The quantified level of loudness of output sound waves is measured in dB every 5 seconds. Each time it is measured, the processing unit 108 categorizes it into one of five ranges of loudness levels. For each range, there is a time count assigned based on WHO's recommended daily maximum exposure. The louder the range, the greater the time count. In the MCU, there is a preset integral value of 8121600, of which the time count of each loudness level range will be subtracted from every 5 seconds. When the value is eventually deducted to 0, the processing unit 108 will automatically bring the volume of the output audio signal down to 85 decibels.

According to the daily maximum exposure recommendations published by the World Health Organization, the preset integral value of 8121600 will eventually reach 0 after deducting the various time counts based on the loudness of the output audio signal that is measured every 5 seconds. Once the value reaches 0, the processing unit 108 will automatically reduce the output audio signal to 85 decibels.

The plurality of instructions includes at least one of a first instruction to maintain no change to the measured quantified level of loudness of the output sound waves, and a second instruction to reduce the measured quantified level of loudness of the output sound waves to the pre-stored quantified value of sound waves.

In an embodiment, the processing unit 108 adjusts the output sound waves to a pre-defined value of sound waves in case the compared quantified level of loudness of the output sound waves exceeds from the pre-stored quantified value of the sound waves. The output audio source 112 receives the adjusted output sound waves from the processing unit 108.

Further, the output audio source 112 produces an audio signal based on the plurality of instructions received by the processing unit 108. The present system 100 visually alerts and notifies the users of their amount of noise exposure, and allowing the users to monitor and correct their listening habits.

In operation, the noise cancellation circuitry 104 cancels up to 95% of ambient noise such that the user predominantly hears sound from the headphones itself. The microcontroller unit (MCU) 110 then monitors the listening duration of the user in association to a range of output volume levels that is above 85 db. Once the microcontroller unit (MCU) 110 detects that the user has reached the daily maximum listening exposure on a given day, it will automatically alert the user audibly and visually, and reduce the output volume level to the optimum level of 85 db.

Subsequently, the user may still have the liberty to adjust the volume level to his/her preference. If he/she brings the volume level back up to above 85 dB, the system 100 may start monitoring the listening duration for each volume level again. When the user reaches his/her daily maximum listening exposure for the second time, the system 100 may alert and automatically reduce the output volume level to 85 dB once again. This time, if the user increases the volume level again, the system 100 interprets that he/she wants to listen at an unsafe volume level. The automatic volume adjustment will then stop the operation.

In an exemplary embodiment, once the daily maximum listening exposure is reached, a built-in automatic alert and notification unit of the present system will do one of two things depending on the mode the user has selected.

MODE 1: As the daily maximum listening exposure is reached, an alert tone is played, volume fades to 85 dB and LED turns its color from green to blue. On second daily maximum exposure during the same listening session, an alert tone is played again as a last warning, volume fades to 85 dB and the LED turns its color from blue to red. Further the user will be free to adjust the volume but there will be no third warning.

MODE 2: As the daily maximum listening exposure is reached, a LED turns its color from green to blue. The volume would not fade back to 85 dB and will stay at current levels. There is only one alert in this mode and user can adjust the volume as he desires.

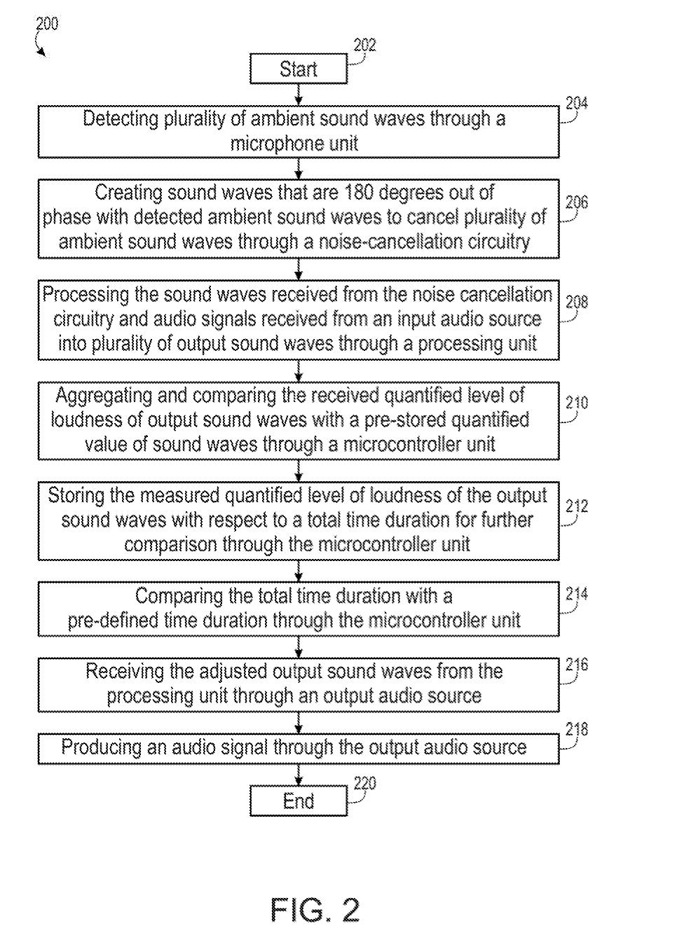

FIG. 2 is a flowchart 200 that illustrates a method for monitoring plurality of sound waves, and further adjusting the sound waves based on the monitored sound waves, in accordance with at least one embodiment. The flowchart 200 is described in conjunction with FIG. 2. The method starts at step 202.

The method includes the step 204 of detecting plurality of ambient sound waves received from through a microphone unit. Then the method includes the step 206 of creating sound waves that are 180 degrees out of phase with the detected ambient sound waves in order to cancel plurality of ambient sound waves through a noise-cancellation circuitry.

Further the method includes the step 208 of processing the sound waves received from the noise cancellation circuitry and audio signals received from an input audio source into plurality of output sound waves through a processing unit. In an embodiment, the processing unit further measures a quantified level of loudness of the output sound waves.

Furthermore, the method includes the step 210 of aggregating and comparing the received quantified level of loudness of output sound waves with a pre-stored quantified value of sound waves through a microcontroller unit. In an embodiment, the processing unit adjusts the output sound waves to a pre-defined value of sound waves in case the compared quantified level of loudness of the output sound waves exceeds from the pre-stored quantified value of the sound waves.

Then the method includes the step 212 of storing the measured quantified level of loudness of the output sound waves with respect to a total time duration for further comparison through the microcontroller unit. The method further includes the step 214 of comparing the total time duration with a pre-defined time duration through the microcontroller unit.

Further the method includes the step 216 of receiving the adjusted output sound waves from the processing unit through an output audio source. Lastly the method includes the step 218 of producing an audio signal through the output audio source. Control passes to end step 220.

Thus, the present system and method mitigate the noise-induced hearing loss (NIHL) caused by the headphones usage. The external noise cancellation mechanism prevents the users from turning volume levels of audio device up to unsafe levels to mask ambient noise. Further the present system utilizes digital mechanism to prevent the users from the excessive exposure to unsafe noises through the monitoring of listening durations of volume levels and automatic volume level reduction to safeguarded 85 dB when users reach the daily maximum listening exposure, as recommended by WHO. Additionally, the present system utilizes audible and visual alerts notify users of their amount of noise exposure, stimulating responsible listening habits and allowing parents to monitor and correct the listening habits of their children.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms enclosed. On the contrary, the intention is to cover all modifications, alternative constructions, and equivalents falling within the spirit and scope of the invention, as defined in the appended claims. Thus, it is intended that the present invention cover the modifications and variations of this invention, provided they are within the scope of the appended claims and their equivalents.

1. A system to monitor plurality of sound waves, and further adjust the sound waves based on the monitored sound waves, the system comprising:
a microphone unit to detect plurality of ambient sound waves after turning on the microphone unit;
a noise-cancellation circuitry to create sound waves that are 180 degrees out of phase with the detected ambient sound waves in order to cancel plurality of ambient sound waves;
a processing unit to process the sound waves received from the noise cancellation circuitry and audio signals received from an input audio source into plurality of output sound waves, wherein the processing unit further measures a quantified level of loudness of the output sound waves; and
a microcontroller unit to aggregate and compare the received quantified level of loudness of output sound waves with a pre-stored quantified value of sound waves, wherein the processing unit adjusts the output sound waves to a pre-defined value of sound waves in case the compared quantified level of loudness of the output sound waves exceeds from the pre-stored quantified value of the sound waves.

2. The system according to claim 1, wherein the microcontroller unit stores the measured quantified level of loudness of the output sound waves with respect to a total time duration for further comparison.

3. The system according to claim 1, wherein the microcontroller unit compares the total time duration with a pre-defined time duration, thereafter plurality of instructions are transmitted to the processing unit.

4. The system according to claim 1, wherein the plurality of instructions includes at least one of: a first instruction to maintain no change to the measured quantified level of loudness of the output sound waves; and a second instruction to reduce the measured quantified level of loudness of the output sound waves to the pre-stored quantified value of sound waves.

5. The system according to claim 1, wherein the pre-stored quantified value of sound waves is about 85 decibels.

6. The system according to claim 1 further includes an output audio source to receive the adjusted output sound waves from the processing unit.

7. The system according to claim 1, wherein the output audio source produces an audio signal based on the plurality of instructions received by the processing unit.

8. The system according to claim 1, wherein the processing unit is a digital signal processor (DSP).

9. A method for monitoring plurality of sound waves, and further adjusting the sound waves based on the monitored sound waves, the method comprising the steps of:
detecting plurality of ambient sound waves through a microphone unit;
creating sound waves that are 180 degrees out of phase with the detected ambient sound waves in order to cancel plurality of ambient sound waves through a noise-cancellation circuitry;
processing the sound waves received from the noise cancellation circuitry and audio signals received from an input audio source into plurality of output sound waves through a processing unit, wherein the processing unit further measures a quantified level of loudness of the output sound waves; and
aggregating and comparing the received quantified level of loudness of output sound waves with a pre-stored quantified value of sound waves through a microcontroller unit, wherein the processing unit adjusts the output sound waves to a pre-defined value of sound waves in case the compared quantified level of loudness of the output sound waves exceeds from the pre-stored quantified value of the sound waves.

10. The method according to claim 9 further includes the step of storing the measured quantified level of loudness of the output sound waves with respect to a total time duration for further comparison through the microcontroller unit.

11. The method according to claim 9 further includes the step of comparing the total time duration with a pre-defined time duration through the microcontroller unit, thereafter transmitting the plurality of instructions to the processing unit.

12. The method according to claim 9, wherein the plurality of instructions includes at least one of: a first instruction to maintain no change to the measured quantified level of loudness of the output sound waves; and a second instruction to reduce the measured quantified level of loudness of the output sound waves to the pre-stored quantified value of sound waves.

13. The method according to claim 9, wherein the pre-stored quantified value of sound waves is about 85 decibels.

14. The method according to claim 9 further includes the step of receiving the adjusted output sound waves from the processing unit through an output audio source.

15. The method according to claim 9 further includes the step of producing an audio signal through the output audio source, based on the plurality of instructions received by the processing unit.

16. The method according to claim 9, wherein the processing unit is a digital signal processor (DSP).
